(19) United States
(12) Patent Application Publication
(10) Pub. No.: US 2014/0191911 A1
(43) Pub. Date: Jul. 10, 2014

(54) Antenna Assembly

(71) Applicants: Michael Merrick, Novi, MI (US); Qian Li, Novi, MI (US); Takehito Onuki, Novi, MI (US); Sowjanya Kolli, Novi, MI (US); Adham Izi, Novi, MI (US)

(72) Inventors: Michael Merrick, Novi, MI (US); Qian Li, Novi, MI (US); Takehito Onuki, Novi, MI (US); Sowjanya Kolli, Novi, MI (US); Adham Izi, Novi, MI (US)

(21) Appl. No.: 14/147,044

(22) Filed: Jan. 3, 2014

Related U.S. Application Data
(60) Provisional application No. 61/749,624, filed on Jan. 7, 2013.

(51) Int. Cl. H01Q 1/32

(52) U.S. Cl. CPC H01Q 1/3291
USPC 343/712

(57) ABSTRACT

A vehicle component having a housing made of non-metallic material and having at least one surface made of metallic material is provided, and an antenna assembly is disposed in the vehicle component. The antenna assembly includes a high-gain film-type antenna element having an input for receiving a wireless signal, an output, and a ground portion is disposed on said non-metallic portion of the housing of said vehicle component. The antenna assembly also includes a low noise amplifier (LNA) and a feeding structure including a coaxial cable and a ground wire. The coaxial cable establishes electrical communication between the antenna element and the LNA, and the ground wire establishes an electrical connection between the ground portion of the antenna element and the metallic surface of the vehicle component.

### CROSS-REFERENCE TO PRIOR APPLICATION

This U.S. Patent Application claims the benefit of U.S. Provisional Patent Application Ser. No. 61/749,624 filed Jan. 7, 2013, entitled “Antenna Assembly,” the entire disclosure of the application being considered part of the disclosure of this application and hereby incorporated by reference.

### BACKGROUND OF THE INVENTION

1. Field of the Invention

The present invention relates generally to antenna assemblies and, more specifically, to antenna assemblies for passenger vehicles.

2. Related Art

Antennas have traditionally been disposed on the exteriors of passenger vehicles and in the plain view of both the driver and others outside of the vehicle. Such antennas were traditionally rod-type antennas which extended outwardly from the front portion, the back portion or the roof of the vehicle. However, such a rod-type antenna may inhibit the driver's visibility and/or take away from the visual appeal or look of the vehicle, thus making the vehicle less desirable in the market.

In order to enhance the external appearance of the vehicle, manufacturers have developed antennas that are built into the rear windshields of passenger vehicles. However, as with rod-type antennas, such windshield antennas have their limitations. For example, the size of such antennas is limited in order to avoid blocking the driver's visibility. Additionally, such windshield mounted antennas are typically low-gain antennas and require further signal amplification during signal transmission. More specifically, such windshield mounted low-gain antennas require the use of a high-gain low noise amplifier to boost the overall antenna system gain and overall performance of such system. Also, such windshield mounted antenna assemblies using a film-type antenna element typically include very short feeding structures including for example, a short connecting wire, or contact points on the film which touch terminals on the amplifier. Such known feeding structures are generally limited to no more than four inches in length and do not provide a quality ground necessary for grounding the antenna assembly.

Other manufacturers have placed antenna systems in other locations of the vehicle such as inside the vehicle cabin or within vehicle panels including the fender and side panels. However, such locations often result in reduced performance as well as increased manufacturing costs from at least partially due to the inclusion of a high-gain low noise amplifier.

Thus, there remains a significant and continuing need for an improved antenna assembly that is cost effective, hidden from view and results in improved antenna performance.

### SUMMARY OF THE INVENTION

An improved antenna assembly, a vehicle component having an improved antenna assembly, and a method of coupling an antenna assembly to a vehicle are provided.

According to one aspect of the present invention, the vehicle component includes an antenna assembly with a high-gain film type antenna element having an input for receiving a wireless signal, an output, and a ground portion. The antenna element is disposed on a non-metallic portion of the housing of a vehicle component. A low noise amplifier (LNA) is in electrical communication with the output of the antenna element, and a ground wire is in electrical connection with the ground portion of the antenna element and the metallic surface.

Another aspect of the present invention provides for an antenna assembly for disposition in a vehicle component having a housing made at least partially of a non-metallic material and having at least one surface made of a metallic material. The antenna assembly includes a high gain film-type antenna element having an input for receiving a wireless signal, an output, and a ground portion. The antenna assembly further includes an LNA and a feeding structure having a coaxial cable. The coaxial cable establishes electrical communication between the output of the film-type antenna element and the LNA.

Yet another aspect of the present invention provides for a method of coupling an antenna to a vehicle. The method includes the step of preparing a vehicle component having a housing made of a non-metallic material and having a surface made of a metallic material. Additionally, the method includes the step of placing a high-gain film-type antenna element having an input for receiving a wireless signal, an output, and a ground portion on the non-metallic housing of the vehicle component. The method further includes the steps of placing a low noise amplifier in the vehicle component. A coaxial cable is coupled to the output of the film-type antenna element. A ground wire is coupled to the ground portion of the film-type antenna element and to the metallic surface of the vehicle to provide an adequate ground to the assembly. The method provides for an improved performance of the assembly based on the configuration of the assembly.

The aspects disclosed herein provide various advantages. For example, the use of a film-type antenna element enables increased flexibility of installation in the vehicle without altering the vehicle's styling or external appearance. The film-type antenna element also allows for improved passive performance and for installation advantages. Specifically, the flexibility of the film-type antenna element allows for easy expansion to occupy the available space for the antenna element, which contributes to the improved passive performance. The passive performance of the antenna assembly is still further improved by the LNA which provides reduced quality deterioration due to interference as compared to other known amplifiers. Further, the film-type antenna element is tunable to the non-metallic material of the housing of the vehicle component to provide the antenna assembly with improved performance. In other words, the film-type antenna element may be tuned to account for the effect of the dielectric property of the non-metallic material and to a desired frequency by the antenna element pattern. Additionally, the configuration of the assembly provides for an overall enhanced performance as it allows for the placement of the assembly is away from the engine of the vehicle and other electrical devices that could produce noise. Although it may be useful to position the antenna element remote from the vehicle engine, it should be appreciated that any position in a vehicle may be possible depending on the vehicle, engine, and antenna designs selected.

### BRIEF DESCRIPTION OF THE DRAWINGS

Other advantages of the present disclosure will be readily appreciated, as the same becomes better understood by reference to the following detailed description when considered in connection with the accompanying drawings wherein:

FIG. 1A is a rear view of a vehicle having the antenna assembly disposed in a wheel-well of the vehicle and hidden from the driver and others outside of the vehicle in accordance with the present disclosure;

FIG. 1B is another rear view of a vehicle having the antenna assembly disposed in a bumper of the vehicle and hidden from the driver and others outside of the vehicle in accordance with the present disclosure;

FIG. 1C is another rear view of a vehicle having the antenna assembly disposed in a rear deck lid of the vehicle and hidden from the driver and others outside of the vehicle in accordance with the present disclosure;

FIG. 2 is an illustration of the antenna assembly in accordance with the present disclosure;

FIG. 3 is a block diagram of the antenna assembly in accordance with the present disclosure;

FIG. 4 is a circuit diagram of the antenna assembly in accordance with the present disclosure; and

FIG. 5 is a flowchart for a method for coupling an antenna to a vehicle in accordance with the present disclosure.

### DETAILED DESCRIPTION OF THE ENABLING EMBODIMENTS

Detailed examples of the present disclosure are disclosed herein; however, it is to be understood that the disclosed examples are merely exemplary and may be embodied in various and alternative forms. It is not intended that these examples illustrate and describe all possible forms of the invention. Rather, the words used in the specification are words of description rather than limitation, and it is understood that various changes may be made without departing from the spirit and scope of the invention.

One aspect of the present invention provides for a vehicle component having a housing made of a non-metallic material and an antenna assembly. The antenna assembly includes a high-gain film-type antenna element, a low noise amplifier, and a feeding structure. Another aspect provides for a method for coupling an antenna assembly and a method for receiving a wireless signal.

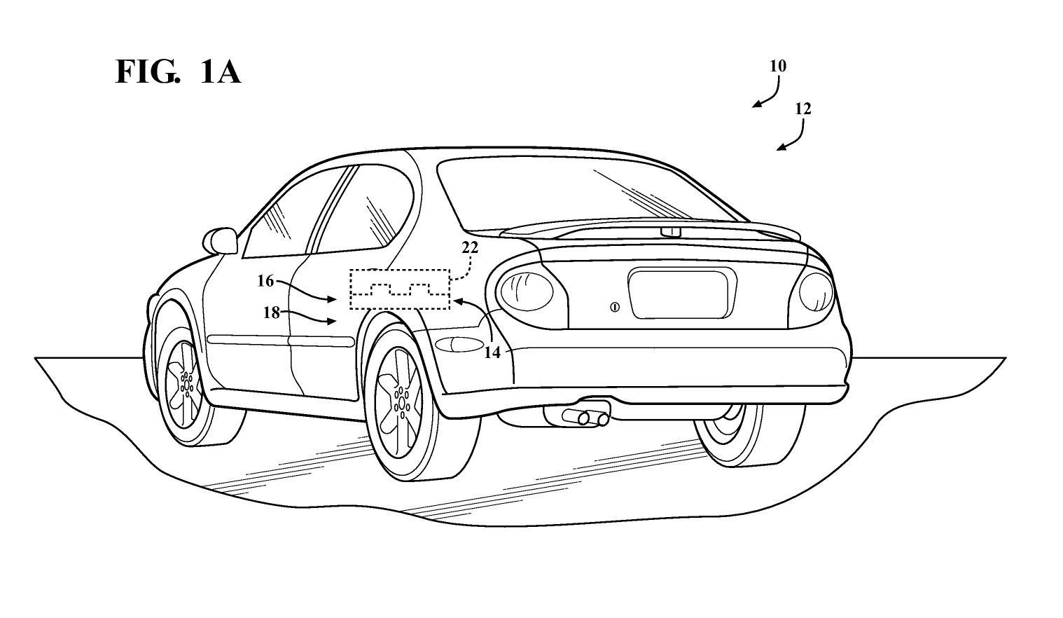

FIG. 1A is a rear view of a vehicle 10 having an antenna assembly 12 disposed on an inner surface of a wheel well 14 and hidden from the driver and others outside of the vehicle 10. The vehicle 10 may be any type of passenger vehicle 10, including, for example, a passenger car, a sport utility vehicle, a truck, etc. The body 16 of the vehicle 10 may be made of both metallic and non-metallic materials. The vehicle component 14 has a housing 18 which is at least partially made of non-metallic material and also has at least one surface 20 which is made of metallic material. The antenna assembly 12 includes a film-type antenna element 22 disposed on the inner surface of the non-metallic housing 18 of the vehicle component. The antenna element 22 may have, but is not limited to, a portion with a generally square wave shape or configuration.

FIG. 1B is a rear view of a vehicle 10 having an antenna assembly 12 disposed within a bumper 14 and hidden from the driver and others outside of the vehicle 10. The vehicle 10 may be, but is not limited to, any standard vehicle 10, including a sport vehicle 10 or a non-sport vehicle 10. The body 16 of the vehicle 10 is similar to the vehicle 10 described in regards to FIG. 1A and is made of both metallic and non-metallic materials. The antenna assembly 12 may include a film-type antenna element 22 disposed on the inner surface of the non-metallic housing 18 or bumper. The antenna element 22 may have, but is not limited to, a portion with a generally square wave shape or configuration.

FIG. 1C is a rear view of a vehicle 10 having an antenna assembly 12 disposed within a rear deck lid 14 and hidden from the driver and others outside of the vehicle 10 in accordance with the present disclosure. The vehicle 10 may be, but is not limited to, any standard vehicle 10, including a sport vehicle 10 or a non-sport vehicle 10. The body 16 of the vehicle 10 is similar to the vehicle 10 described in regards to FIG. 1A and may be made of metallic and non-metallic materials. The antenna assembly 12 may include a film-type antenna element 22 disposed on the inner surface of the non-metallic housing 18 or deck lid. Further, the antenna element 22 may have, but is not limited to, a portion a generally square wave shape or configuration.

As those of ordinary skill in the art will understand various features of the present disclosure as illustrated and described with reference to any of the Figures may be combined with features illustrated in one or more other Figures to produce examples of the present disclosure that are not explicitly illustrated or described. The combinations of features illustrated provide representative examples for typical applications. However, various combinations and modifications of the features consistent with the teachings of the present disclosure may be desired for particular applications or implementations.

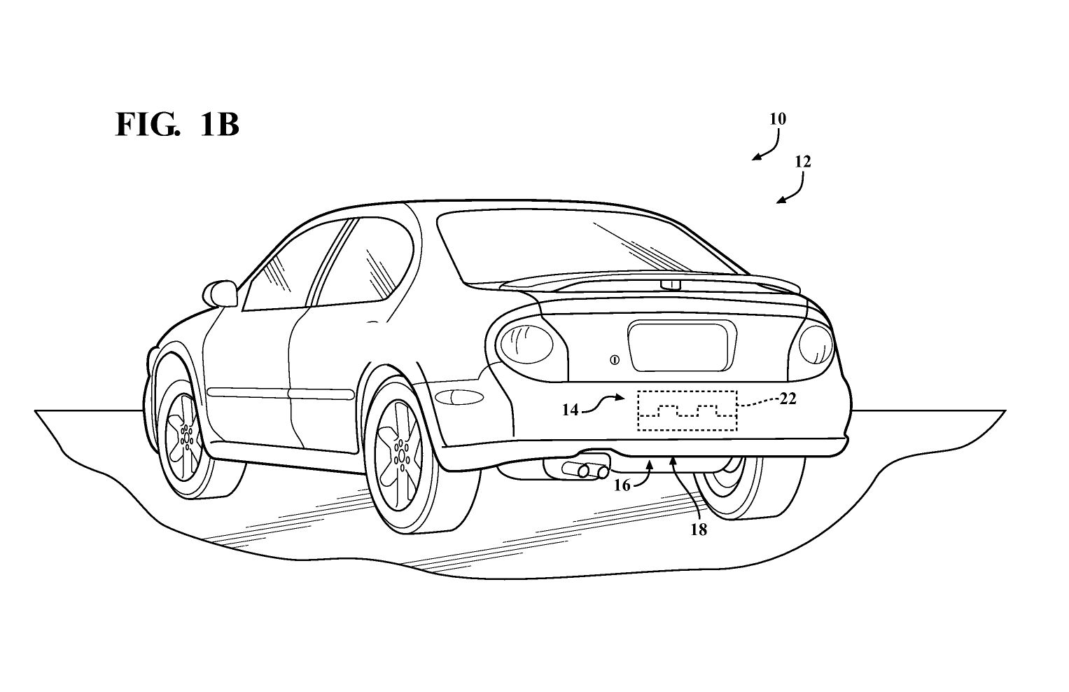

Referring now to FIG. 2, the antenna assembly 12 includes a high-gain film-type antenna element 22 which has a film layer 24 and a substrate element 26. The film layer 24 is made of a polymeric material, and the substrate element 26 is made of a conductive material in the form of an overlay or wire such as copper. The use of the film-type antenna element 22 permits many different shapes and sizes to be formed and for the antenna element 22 to be mounted on the non-metallic housing 18 of the vehicle component 14. It should be appreciated that the film layer 24 and the substrate element 26 may be formed in many different shapes and sizes depending on the geometric shape of the vehicle component 14 to which it is to be attached. It also should be appreciated that the film layer 24 and the substrate element 26 is flexible and has the ability to expand among available space of the non-metallic housing 18. The expansion of the antenna element 22 provides an overall better passive performance of the antenna element 2 and in particular provides for better signal reception.

In one presently preferred embodiment, the polymeric material of the film layer 24 is a Mylar-type film and has a generally rectangular shape. Also, the substrate element 26 is a copper overlay and has a generally square wave configuration. However, it should be appreciated that the film layer 24 may have square shape and the substrate element 26 may have, for example, a copper wire or another conductive material in a sinusoidal wave configuration or a linear configuration.

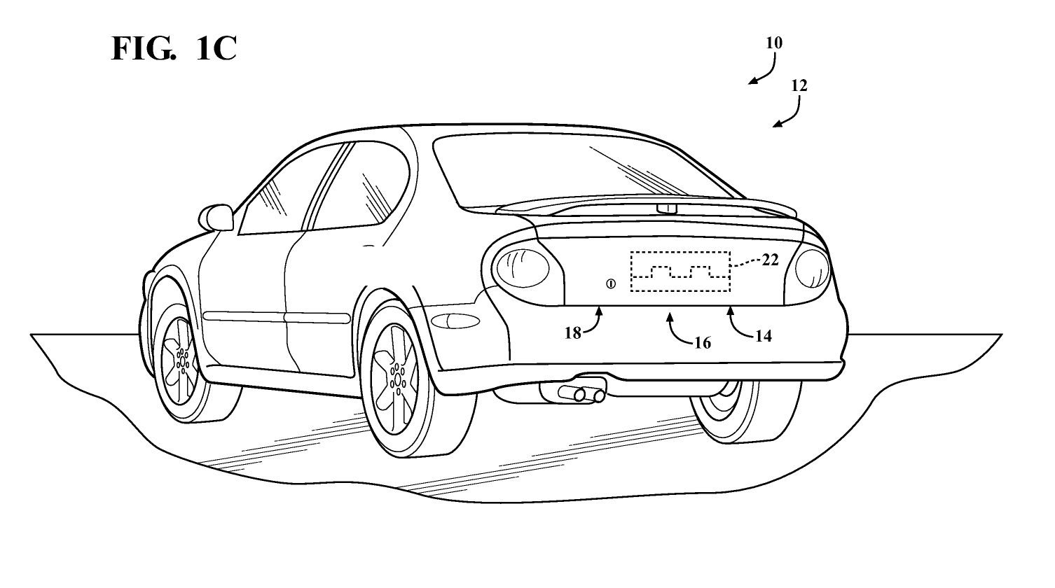

Referring still to FIG. 2, one side of the antenna element 22 has adhesive material disposed thereon which permits coupling to the inner surface of the vehicle component 14 as described above and shown in FIGS. 1A, 1B, and 1C. Additionally, the antenna element 22 has an input 28 for receiving a wireless signal. The input 28 of the antenna element 22 may be an input terminal located on the substrate element 26, for example. Alternatively, the input 28 may be a plurality of input terminals disposed along the substrate element 26. The plurality of input terminals may be capable of receiving and transmitting one signal at a time or multiple signals at a time. The antenna element 22 also has an output for transmitting the signals received via the input 28 to a low noise amplifier (LNA) 40 (shown in FIG. 3). The antenna element 22 of FIG. 2, may be isotropic and may radiate power uniformly in all direction or may be directional and may only transmit and receive radio waves in one direction, e.g., towards the output 30 of the substrate element 26. The antenna element 22 may also be tuned to a desired frequency based on its location and the material on the non-metallic housing 18 of the vehicle components 14. In other words, the antenna element 22 may take into account the aspects of the non-metallic housing 18, specifically, the dielectric material of the non-metallic housing 18 and may by tuned to a desired frequency based on the pattern of the antenna element 22 and the non-metallic housing 18. Further, the exemplary antenna element 22 includes a ground portion 32 in the form of a ground plane provided for grounding the antenna element 22.

The exemplary antenna assembly 12 of FIG. 2 also includes a feeding structure 34 which has a coaxial cable 36 that is electrically connected with the output 30 and with the LNA 40 (shown in FIG. 3). The coaxial cable 36 has a ground portion for stabilizing signals transmitted through the coaxial cable 36 and a signal portion for transmitting data or information. Additionally, the coaxial cable 36 enhances overall performance of the system as the cable 36 allows for optimization of the signal during transmission between the antenna element 22 and the LNA 40 (shown in FIG. 3). The feeding structure 34 further includes a ground wire 38 which is positioned parallel to the coaxial cable 36 and establishes an electrical connection between the ground portion 32 of the antenna element 22 and the metallic surface of the vehicle 10 to provide the antenna assembly with a chassis ground point. FIG. 3 is a block diagram of the vehicle 10 and the antenna assembly 12 in accordance with the present disclosure. As shown, the antenna element 30 is in electrical communication with the low noise amplifier (LNA) 40. The gain of the LNA 40 is adjusted according to the passive gain of the antenna element 22, which is typically 12 dBi or greater. Typically, the gain on the LNA 40 is less than 3.0 dB. Furthermore, the LNA 40 is in electrical communication with a radio receiver 42 which converts any signals received by the antenna element 22 and amplified by the LNA 40 into a useable form for a given device such as but not limited to a vehicle FM/AM radio, global positioning system, or telephone. Overall, the use of the LNA 40 and the film-type antenna element 22 on the non-metallic housing 18 of the vehicle component 14 provides for improved antenna reception with lower noise or interference.

FIG. 3 also shows a feeding structure 34, which includes a coaxial cable 36 as discussed above, denoted by the dashed line A. The coaxial cable 36 permits electrical communication between the antenna element 22 and the LNA 40. Specifically, the coaxial cable 36 has a first end in electrical communication with the output 30 of the antenna element 22 and a second end in electrical communication with to the LNA 40. As discussed above, the coaxial cable 36 has a ground portion and a signal portion for use in signal transmission. The signal portion allows transmission of data or information in the form of a signal between multiple components. The ground portion of the coaxial cable 36 stabilizes any signal transmitted through the coaxial cable. As such, the coaxial cable 36 enhances overall performance of the system by allowing for optimization of the signal during transmission between the antenna element 22 and the LNA 40 and by providing a ground to the LNA 40.

Typically, amplifiers are connected to their respective antenna elements using a short wire or contact points positioned on the film element itself. As such the feed wire in the prior art is typically no longer than four inches. In the present disclosure, the use of the coaxial cable 36 or coaxial cable permits the antenna element 22 to be positioned further from the LNA 40. For example, in the preferred embodiment, the antenna element 22 and the LNA 40 may be positioned approximately twenty (20) inches from one another. In other words, the antenna element 22 may be position further from the LNA 40 than other known antenna elements can be from their respective amplifiers. As a result, the antenna element 22 may be mounted on the non-metallic housing 18 of the vehicle 10 which also improves the overall performance of the antenna assembly 12 within the vehicle 10.

Referring still to FIG. 3, the ground wire 38 of the exemplary feeding structure 34 has a first end which is in electrical contact with the output 30 of the antenna element 22 and a second end which is in electrical contact with the metallic surface 20 of the vehicle component 14 for providing ground to the entire antenna assembly 12. This improves the overall passive performance of the antenna element 22 as well as limits static electricity or interference which may negatively affect the antenna assembly 12. The metallic surface 20 may be, but is not limited to, a plate mounted on the vehicle body 16. The LNA 40 is mounted on the plate and the plate may also provide ground to the LNA 40. Alternatively, the metallic surface 20 may be a chassis component or a cover affixed to another metallic portion of the vehicle 10. The cover may encompass the antenna element 22, the LNA 40, and the feeding structure 34 for providing protection to the components from environmental condition surrounding the vehicle 10. Additionally, the coaxial cable 36 and the ground wire 38 may be parallel to one another. In an alternative embodiment, a second ground wire may be in electrical contact with the LNA 40 and the metallic surface 20 to provide a ground to the LNA 40 and improve the overall performance of the LNA 40.

In operation, the antenna element 22 receives a radio frequency (RF) signal produced by a FM/AM radio, satellite radio, global positioning systems (GPS), a cell phone or a vehicle telephone, or Bluetooth from a radio transmitter. The antenna element 22 transmits the signal through the coaxial cable 36 to the LNA 40. The LNA 40 may be in electrical communication with the radio receiver 42 via a RF cable 44 or wirelessly. The LNA 40 amplifies or “boosts” the signal strength before transmitting the signal to the radio receiver 42. This allows the signal to be presented in a better format for the radio receiver 42. The radio receiver 42 converts the signal into a useable form for a given device such as the radio. In other words, the radio receiver 42 converts the signal into a format that the user may hear, see (for example, on a liquid crystal display), or otherwise understand. This combination of components in conjunction with the non-metallic housing 18 positioned away from the engine results in low interference or noise experienced by the antenna element 22 when receiving the wireless signal and transmitting the signal to the LNA 40 as well as the radio receiver 42. In other words, the placement of the components provides for an overall enhanced performance of the antenna element 22 and the antenna assembly 12 for the user of the vehicle 10.

For example, a radio station may broadcast music over FM radio utilizing a radio transmitter. The radio transmitter transmits the radio waves within a given range. The antenna element 22 of the vehicle 10 within the given range receives the radio waves via the input 28 of the antenna element 22. The antenna element 22 transmits current based on the radio waves through the coaxial cable 36 to the LNA 40 for signal amplification. The amplified signal is transmitted to a radio receiver 42 which converts the signal into a useable form such as information indicative of the song or music the radio station is broadcasting. The radio receiver 42 transmits the converted information to the vehicle radio which plays the music broadcasted by the radio station. The placement of the antenna element 22 and assembly 12 within the vehicle 10 provides an improved performance in transmitting and receiving the signals and overall enhances a user's experience in the vehicle.

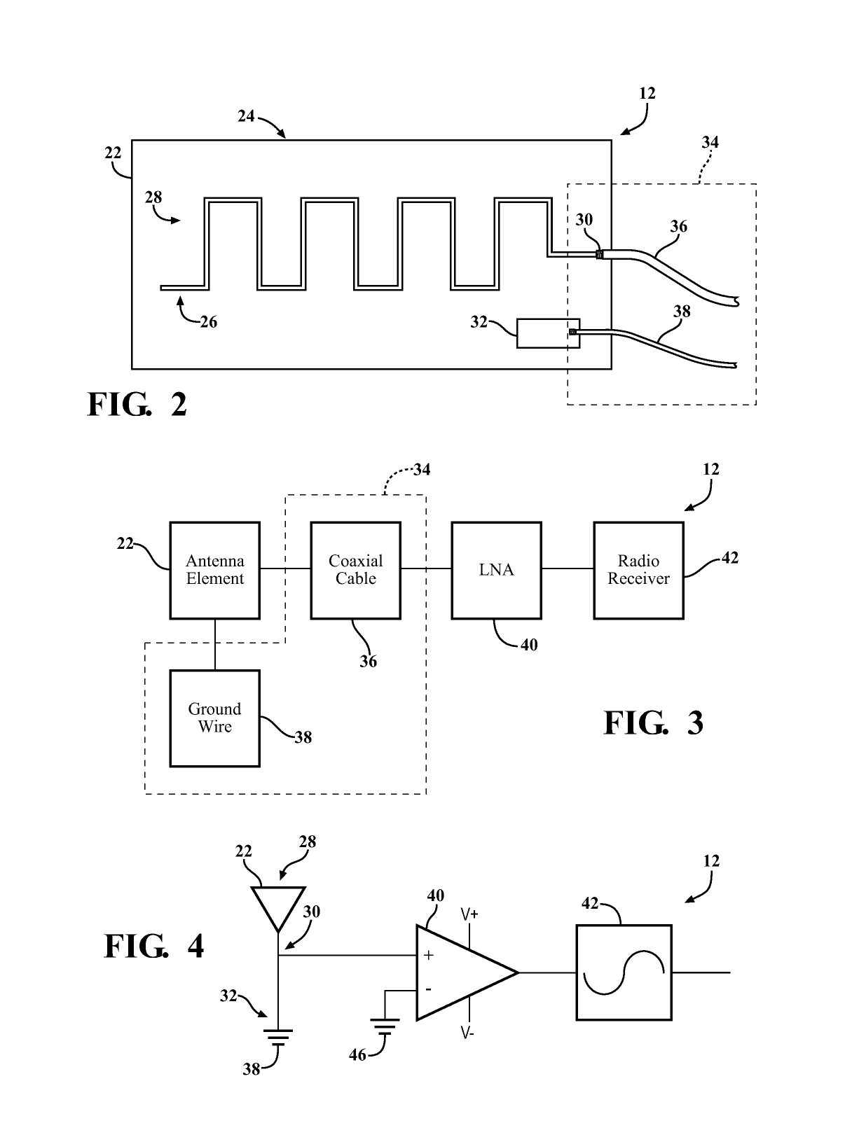

Referring now to FIG. 4, a circuit diagram of the antenna assembly 12 in accordance with the present disclosure is provided. The antenna assembly 12 includes an antenna element 22 having an input 28 for receiving signal, an output 30, and a ground portion 32. A second ground or ground wire 38 is in electrical communication with the ground portion 32 of the antenna assembly 12 to provide ground to the antenna element 22. Additionally, the output 30 of the antenna element 22 is in electrical communication with an input of the LNA 40. The +V and −V connections of the LNA 40 denote the positive and negative sides for connection to a DC power supply. The LNA 40 may have a third ground 46 or a separate ground from the antenna element 22 and the ground wire which is in electrical connection with the −V connections or the negative connection of the LNA 40. In an alternative embodiment, the third ground 46 is in electrical communication with the negative input of the LNA 40. Additionally, the antenna assembly 12 also includes at least one filter. The filter may be located between the antenna element 22 and the LNA 40, located between the LNA 40 and the radio receiver 42, or a combination of both. The filter can be connected through a second coaxial cable. The filter is configured to filter out unnecessary frequencies which may otherwise produce an undesired result in the antenna assembly 12 while the assembly 12 is operating. The filter may be a band-pass filter which only allows transmission of frequencies in a certain range, a high-pass filter which only allows transmission of frequencies above a cutoff frequency or a low-pass filter which only allows transmission of frequencies below a cutoff frequency. The filter provides an improved form or smoother form of the signal and removes fluctuations that cause problems during signal transmission between components.

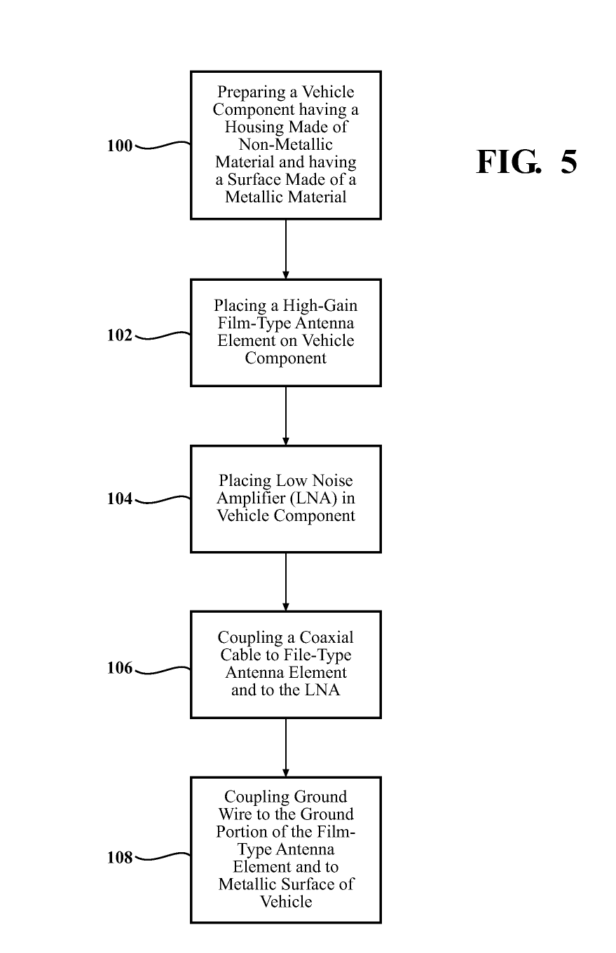

FIG. 5 is a flowchart for a method for coupling an antenna to a vehicle in accordance with the present disclosure. The method includes the steps of preparing a vehicle component having a housing made of a non-metallic material and having a surface made of a metallic material 100 and placing a high-gain film-type antenna element having an input for receiving a wireless signal, an output and a ground portion on the non-metallic housing of the vehicle component 102 could be, for example, a wheel-well, a bumper or a rear deck lid. The film-type antenna element has an input for receiving wireless signals, an output, and a ground portion.

The method further includes the step of placing a low noise amplifier (LNA) in the vehicle component 104. A coaxial cable is coupled to the output of the film-type antenna element and to the LNA 106. Additionally, a ground wire is coupled to the ground portion of the film-type antenna element and to the metallic surface of the vehicle 108. The ground wire provides adequate ground to the antenna element. In the preferred embodiment, the metallic surface of the vehicle may be a plate affixed to the vehicle.

The foregoing disclosure has been illustrated and described in accordance with the relevant legal standards, it is not intended that these examples illustrate and describe all possible forms of the invention, thus the description is exemplary rather than limiting in nature. Variations and modifications to the disclosed embodiment may become apparent to those skilled in the art and fall within the scope of the invention. Additionally, the features and various implementing embodiments may be combined to form further examples of the invention.

What is claimed is:

1. A vehicle component, said vehicle component comprising:
a housing made of a non-metallic material and having at least one surface made of a metallic material;
a high gain film-type antenna element having an input for receiving a wireless signal, an output, and a ground portion, said antenna element being disposed on said non-metallic portion of said housing of said vehicle component;
a low noise amplifier (LNA) in electrical communication with said output of said antenna element; and
a ground wire in electrical connection with said ground portion of said antenna element and said metallic surface.

2. A vehicle component of claim 1, further comprising:
a feeding structure including a coaxial cable, said coaxial cable establishing electrical communication between said output of the film-type antenna and the LNA.

3. A vehicle component as set forth in claim 1, wherein said housing is a wheel-well.

4. A vehicle component as set forth in claim 1, wherein said housing is a bumper.

5. A vehicle component as set forth in claim 1, wherein said housing is a deck lid.

6. A vehicle component as set forth in claim 1, wherein said antenna element includes a film layer and a substrate element.

7. A vehicle component as set forth in claim 6, wherein said film layer of said antenna element is made of a polymeric material.

8. A vehicle component as set forth in claim 7, wherein said polymeric material of said film layer is a mylar-type film.

9. A vehicle component as set forth in claim 6, wherein said substrate element is made of copper.

10. A vehicle component as set forth in claim 6, wherein said substrate element has a generally square wave configuration.

11. A vehicle component as set forth in claim 1, wherein said ground portion of said antenna element is a ground plane.

12. A vehicle component as set forth in claim 1, wherein said at least one metallic surface is a plate affixed to said vehicle.

13. A vehicle component as set forth in claim 1, wherein said at least one metallic surface is a chassis component of the vehicle.

14. A vehicle component as set forth in claim 1, wherein said LNA is in electrical communication with a radio receiver.

15. An antenna assembly for disposition in a vehicle component having a housing made at least partially of non-metallic material and having at least one surface made of metallic material, said antenna assembly comprising:
a high gain film-type antenna element having an input for receiving a wireless signal, an output, and a ground portion;
a low noise amplifier (LNA); and
a feeding structure having a coaxial cable, said coaxial cable establishing electrical communication between said output of the film-type antenna element and said LNA.

16. A vehicle component of claim 15, wherein said feeding structure further includes a ground wire for establishing an electrical connection between said ground portion of said antenna element and a metallic surface of the vehicle component.

17. A method of coupling an antenna to a vehicle, comprising the steps of:
preparing a vehicle component having a housing made of a non-metallic material and having a surface made of a metallic material;
placing a high gain film-type antenna element having an input for receiving a wireless signal, an output and a ground portion on the non-metallic housing of the vehicle component;
placing a low noise amplifier (LNA) in the vehicle component;
coupling a coaxial cable to the output of the film-type antenna element and to the LNA to establish electrical communication between the film-type antenna element and the LNA; and
coupling a ground wire to the ground portion of the film type antenna to the metallic surface of the vehicle to ground the film-type antenna element.
